(19) United States
(12) Patent Application Publication
(10) Pub. No.: US 2004/0090944 A1
(43) Pub. Date: May 13, 2004

(54) Wireless LAN system and method for setting a frequency in the same system

(75) Inventor: Tsukasa Ueno, Tokyo (JP)

Correspondence Address: MCGINN & GIBB, PLLC, 8321 OLD COURTHOUSE ROAD, SUITE 200, VIENNA, VA, 22182-3817, US

(73) Assignee: NEC Corporation, Tokyo (JP)

(21) Appl. No.: 10/665,470

(22) Filed: Sep. 22, 2003

(30) Foreign Application Priority Data
Sep. 20, 2002 (JP) 275269/2002

(51) Int. Cl. H04Q 7/00; H04Q 7/24

(52) U.S. Cl. 370/338; 370/328

(57) ABSTRACT

The invention provides a wireless LAN system and a method for setting a wireless frequency in the same system, which are better in operability and make it possible to determine a frequency through a small amount of operation by automatically judging whether or not a frequency conforms to the specifications in each area or whether or not a frequency is in use, wherein a personal computer has a CPU, a memory for application software and a driver taking charge of an interface with a mobile terminal, and a mobile terminal comprises a PC interface for taking charge of an interface with the personal computer, a control circuit for controlling various operations, a memory for storing data, a frequency setting circuit for setting frequency information sent from the personal computer, a frequency judging circuit for examining whether or not the set frequency is in use, and a wireless transmission/reception circuit for performing a wireless communication with an access point.

### BACKGROUND OF THE INVENTION

1. Field of the Invention

The present invention relates to a wireless LAN (local area network) system and a method for setting a frequency in the same system, and more particularly to a wireless LAN system making it possible to determine a frequency by means of a small amount of selecting operation and a method for setting a frequency in the same system.

2. Description of the Related Art

A wireless LAN is a LAN in which the connection (branch LAN) between terminal devices such as personal computers and the like and a private communication network (LAN: local area network) is made wireless. Main advantages of introducing a wireless LAN are divided broadly into two. One is to make a wiring work for a branch LAN unnecessary, and thereby make it possible to reduce the cost in changing an office layout due to making it unnecessary to perform a troublesome wiring work each time desks are changed in arrangement.

The other advantage is to make it possible for a user to connect its notebook-sized personal computer to a LAN in the same environment as its own seat even when it moves its place. For example, it is possible to take a file suddenly required at the time of presentation in a reception room or the like through a LAN, hold a paperless conference in which each person brings a notebook-sized personal computer with him/her or perform such a cooperative work efficiently as changing a document as consulting. As a result, it is possible to improve the efficiency, mobility and adaptability of work.

In recent years, the number of cases where such a wireless LAN is installed has been increased. Particularly, in case that a user carrying with it a terminal device such as a notebook-sized personal computer or the like provided with a wireless LAN communication function communicates with a private communication network (LAN) installed in a place to which the user moves, it is established to perform communication on the basis of a predetermined wireless communication procedure, and an access point (AP: access point) and a mobile terminal in accordance with such rules as IEEE 802.11.a and the like have been made to be capable of communicating by being tuned to the same frequency as a wireless frequency assigned to an area which they are installed in or moved to.

And there is an ad hoc communication method making it possible for mobile terminals to communicate with each other in case of moving to an area where no access point is installed, and also in such a case, communication between mobile terminals is established by using a wireless frequency determined by a mobile terminal first performing communication out of wireless frequencies assigned to the area to which the mobile terminal has moved.

Up to now, such an access point or a mobile terminal fixedly stores a plurality of wireless frequencies assigned to each area in its own device, and uses a frequency which is ordinarily determined in advance when the access point or the mobile terminal is shipped from a factory out of these stored frequencies as the initial value (default value) of wireless frequencies at the time of starting communication.

FIG. 1 is a block diagram of an access point and a mobile terminal in a conventional wireless LAN system. As shown in FIG. 1, an access point 5 used, for example, in an area called Japan stores in advance frequency data 34 related to wireless frequencies assigned to Japan in it and comprises a frequency setting circuit 33 for setting a wireless frequency on the basis of the frequency data and a wireless transmission/reception circuit 27 for performing a wireless communication with a mobile terminal by means of a determined wireless frequency.

In addition, a mobile terminal 2 used in an area called Japan stores frequency data 32 in advance which is related to wireless frequencies assigned to Japan in its inside and comprises a frequency setting circuit 31 for setting a wireless frequency on the basis of the frequency data and a wireless transmission/reception circuit 17 for performing a wireless communication with an access point or a mobile terminal by means of a determined wireless frequency.

FIG. 2 shows channel allocation (wireless frequency allocation) diagrams of a 5.2 GHz broadband mobile access system (5 GHz wireless LAN system) in Japan, the United States of America and Europe. As shown in FIG. 2, in the frequency allocation in Japan the wireless frequencies of 5170 MHz, 5190 MHz, 5210 MHz and 5230 MHz are allocated as the center frequencies.

Moreover, in the frequency allocation in U.S.A and Europe the wireless frequencies of 5180 MHz, 5200 MHz, 5220 MHz, 5240 MHz, 5260 MHz, 5280 MHz, 5300 MHz and 5320 MHz are allocated as the center frequencies, which are different from the frequency allocation in Japan.

A conventional frequency setting method described above determines frequencies fixedly which is allocated to an area in which an access point or a mobile terminal is used, and has a problem that these frequencies cannot be used as they are kept intact in case that an access point or a mobile terminal which has been finished in setting frequencies in advance is installed in or moved to another area.

Furthermore, in case of determining a wireless frequency by means of the initial value (default value) at the time of shipping a mobile terminal, many mobile terminals accommodated in a wireless LAN result in using the same frequency and this has caused such problems as traffic concentration, radio interference and the like in some frequencies.

That is to say, usable frequencies maybe different depending on areas in case of a wireless LAN system, and in a wireless LAN of 5 GHz band, different usable frequency bands are defined in Japan and U.S.A even though they conform to IEEE 802.11a. Therefore, devices (access points and mobile terminals) shipped for Japan are set so that they can use only frequencies allocated to Japan, and in case of attempting to use them in U.S.A, they need to be set again for frequencies allocated to U.S.A. A frequency setting method being better in operability has been demanded.

### SUMMARY OF THE INVENTION

The present invention has been performed in consideration of the above-mentioned circumstances, and an object of the invention is to provide a wireless LAN system and a method for setting a frequency in the same system which are better in operability and make it possible to determine a frequency through a small amount of operation by providing a user with usable frequency information obtained by automatically judging whether or not each frequency conforms to the specifications in each area or it is a free frequency being not in use.

The present invention performed in order to solve the above-mentioned problem provides a wireless LAN system comprising an access point and a maintenance device connected with each other through a wire network and a mobile terminal performing a wireless communication with said access point, said wireless LAN system being provided with a method for selecting a wireless frequency usable in a relevant area out of wireless frequency data stored on the basis of the area information inputted in either device at the time of setting a wireless frequency for communication.

That is to say, it is possible to determine a frequency through a small amount of selecting operation by providing a user of a mobile terminal or a maintenance person with frequency information obtained by automatically judging whether or not the frequencies conform to the specifications of each area or they are free frequencies being not in use.

Hereupon, said stored wireless frequency data may include area information and all permitted wireless frequency values corresponding to the relevant area information.

Besides, said usable wireless frequency selecting method may be a method which performs a reception operation by means of all wireless frequency values permitted in said area, sends wireless frequencies causing no carrier busy to a maintenance person or a user as usable frequencies as a result of said reception operation and makes the maintenance person or the user select a communication frequency out of said usable frequencies.

Moreover, the present invention provides a wireless LAN system comprising a maintenance device having a man-machine interface, an access point connected to a wire network and a mobile terminal performing a wireless communication with said access point, wherein; said access point may be provided with a method which performs a reception operation by means of all wireless frequency values permitted in a relevant area stored in the maintenance device or the access point on the basis of the area information inputted through the man-machine interface of the maintenance device when setting a wireless frequency for the access point to communicate with the mobile terminal, sends wireless frequencies causing no carrier busy to a maintenance person as usable frequencies as a result of said reception operation and makes the maintenance person select a communication frequency out of said usable-frequencies, and said mobile terminal may be provided with a method which performs a reception operation by means of all wireless frequency values permitted in the relevant area stored in the mobile terminal on the basis of the area information inputted through the man-machine interface of the mobile terminal when setting a wireless frequency for the mobile terminal to communicate with the access point, sends wireless frequencies causing no carrier busy to a user as usable frequencies as a result of said reception operation and makes the user select a communication frequency out of said usable frequencies.

### BRIEF DESCRIPTION OF THE DRAWINGS

The above and other objects, features and advantages of the present invention will become more apparent from the following detailed description when taken in conjunction with the accompanying drawings wherein:

FIG. 1 is a block diagram of an access point and a mobile terminal in a conventional wireless LAN system.

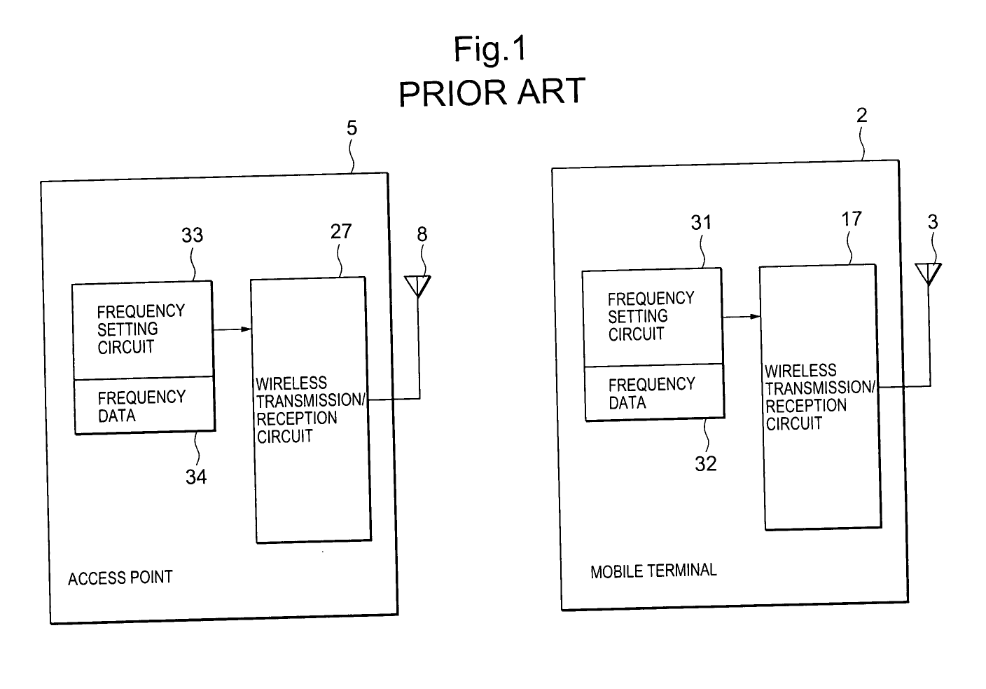

FIG. 2 is channel allocation (wireless frequency allocation) diagrams of a 5.2 GHz broadband mobile access system (5 GHz band wireless LAN system) in Japan, the United States of America and Europe.

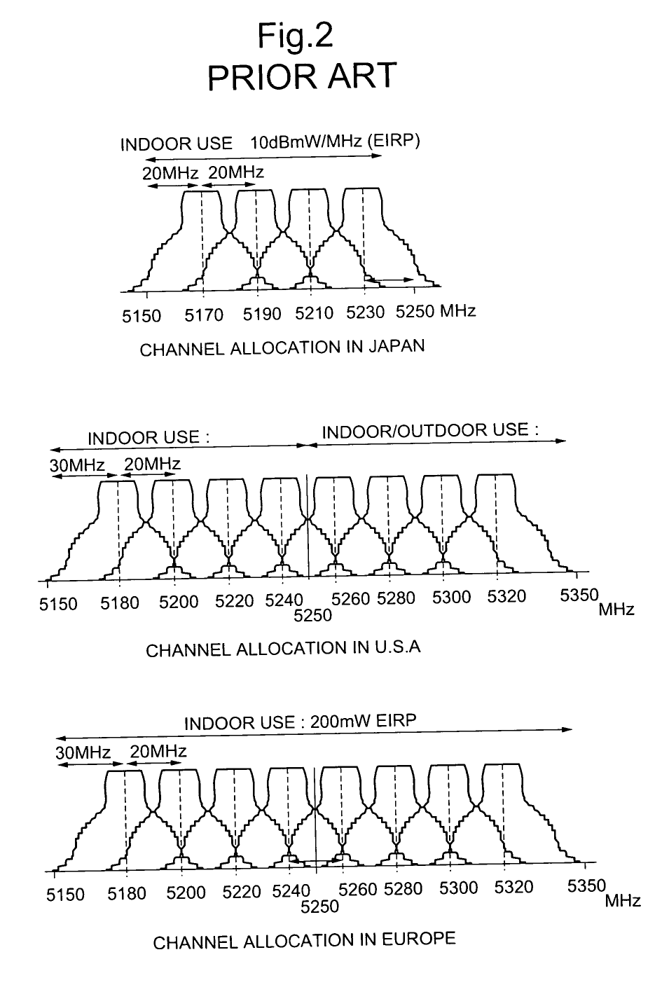

FIG. 3 is an entire schematic block diagram of a wireless LAN system showing a first embodiment of the present invention.

FIG. 4 is a block diagram showing a personal computer (PC) 1 and a mobile terminal (MT) 2 in FIG. 3.

FIG. 5 is a memory map diagram of area/frequency information provided in a memory circuit 15 of the mobile terminal 2.

FIG. 6 is a flowchart showing an operation of setting a frequency in the wireless LAN system of FIG. 3.

FIG. 7 is an entire schematic block diagram of a wireless LAN system showing a second embodiment of the present invention.

FIG. 8 is a block diagram showing a maintenance personal computer (PC) 7 and an access point 5 of FIG. 7.

FIG. 9 is a flowchart showing an operation of setting a frequency in the wireless LAN system of FIG. 7.

FIG. 10 is an entire schematic block diagram of a wireless LAN system showing a third embodiment of the present invention.

FIG. 11 is a block diagram showing a maintenance personal computer (PC) 7 and an access point 5 of FIG. 10.

FIG. 12 is a flowchart showing an operation of setting a frequency in the wireless LAN system of FIG. 10.

### DETAILED DESCRIPTION OF PREFERRED EMBODIMENTS

Preferred embodiments of the present invention will be described below in detail with reference to the drawings.

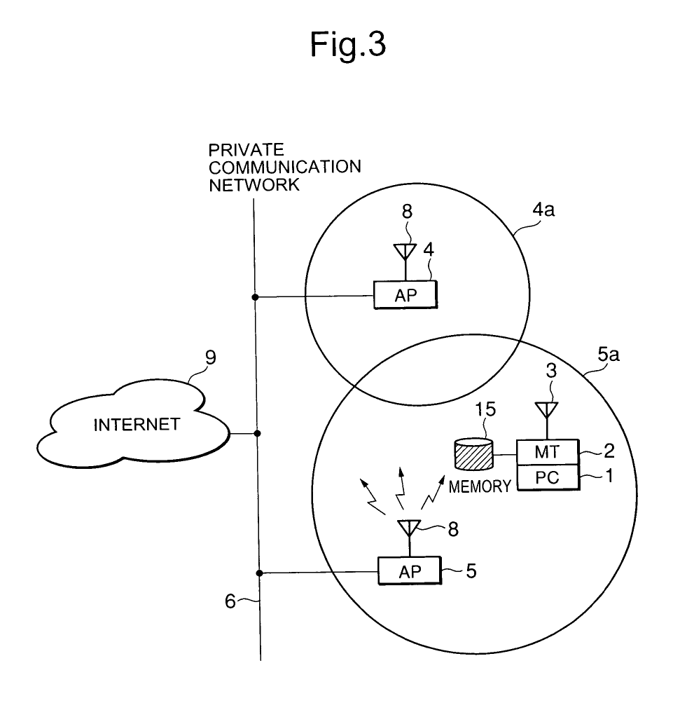

Embodiments of the present invention are described with reference to the drawings in the following. FIG. 3 is an entire schematic block diagram of a wireless LAN system showing a first embodiment of the present invention, and in this embodiment, setting of a wireless frequency is performed by a mobile terminal. As shown in FIG. 3, an access point 4 and an access point 5 each of which is installed in its relevant area are connected to a private communication network (LAN) 6, which is connected to the Internet 9 being a public communication network. Each access point is provided with an antenna 8, which emits a radio wave for performing a wireless communication. And a service area 4a is formed by the access point 4 and a service area 5a is formed by the access point 5.

A mobile terminal 2 is moving (is present) inside the service area 5a and is in communication with the access point 5 through an antenna 3, and a personal computer 1 and a memory 15 are connected to the mobile terminal 2. In FIG. 3 the mobile terminal 2, the personal computer 1 and the memory 15 are respectively separate components, but it goes without saying that the mobile terminal 2 may become a component comprising the personal computer 1 or the memory 15 or both of them.

And the private communication network (LAN) 6 is a wire network, which comprises wire cables, optical fiber cables or the like and network devices such as a router, a hub and the like.

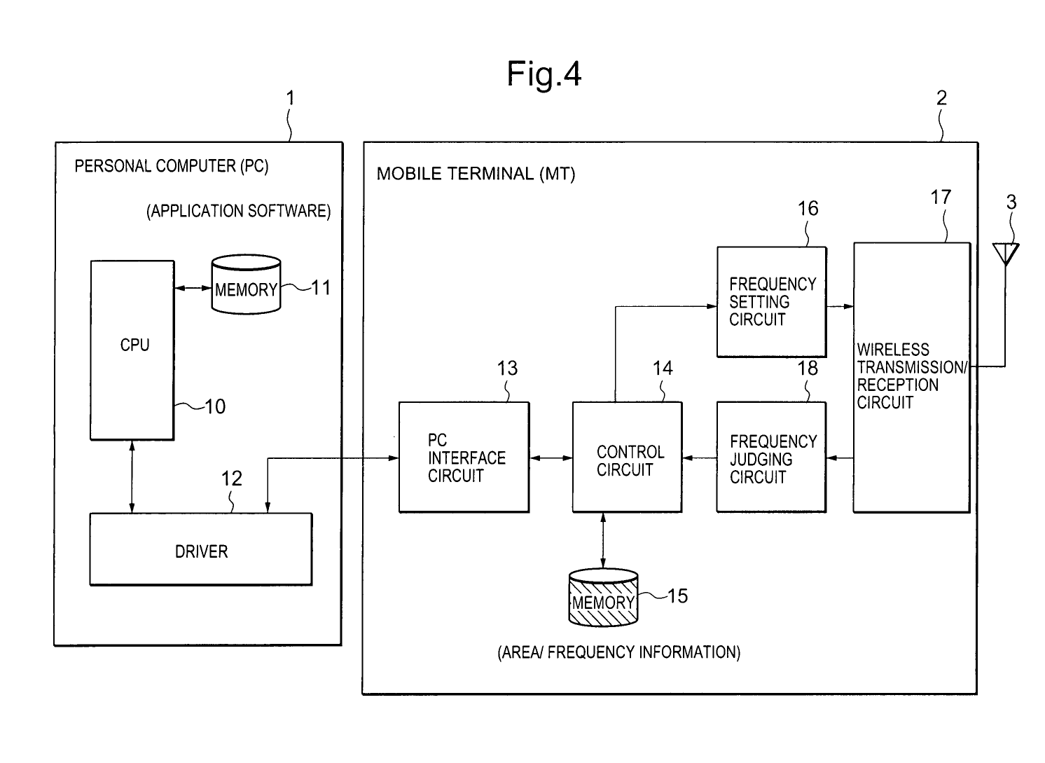

FIG. 4 is a block diagram showing the personal computer (PC) 1 and the mobile terminal (MT) 2 of FIG. 3, and in this case the mobile terminal 2 comprises the memory 15. As shown in FIG. 4, the personal computer 1 is mounted with a CPU 10 for performing control, a memory 11 having application software stored in it and a driver 12 taking charge of an information interface between the said CPU 10 and the mobile terminal 2, and the mobile terminal 2 comprises a PC interface circuit 13 taking charge of an interface with the personal computer 1, a control circuit 14 for controlling various operations, a memory 15 for storing data related to such control operations, a frequency setting circuit 16 for setting wireless frequency information sent from the personal computer 1 to a wireless transmission/reception circuit 17, a frequency judging circuit 18 for examining whether or not a frequency in each area is a free frequency being not in use, and a wireless transmission/reception circuit 17 for performing a wireless communication with an access point.

The block diagram of FIG. 4 only shows the block components taking part in a frequency setting operation, but omits block components participating in other operations (ordinary data transmission/reception operation and the like).

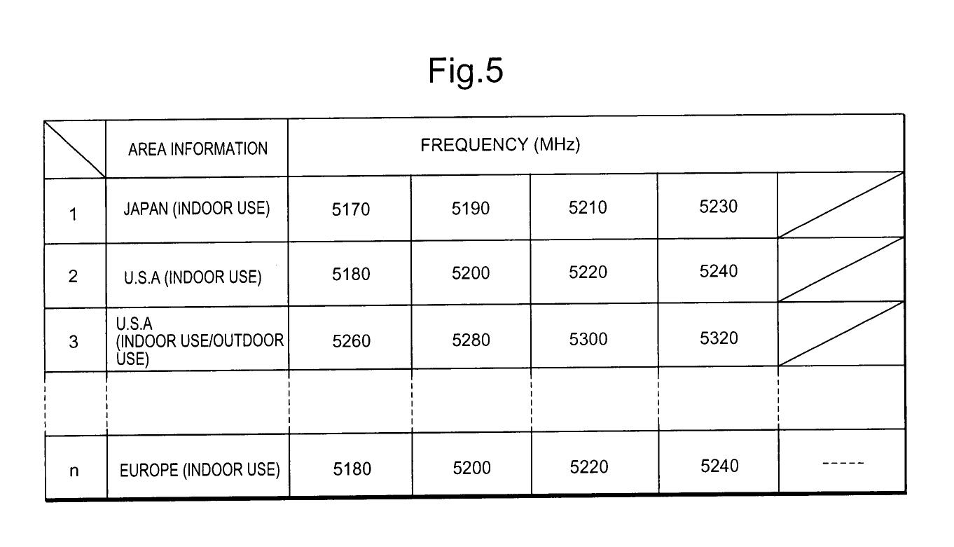

FIG. 5 is a memory map diagram of area/frequency information provided in the memory 15 of the mobile terminal 2. As shown in FIG. 5, area information and frequency information permitted to be used in the relevant area are paired and stored in the memory, and all of concrete frequency information of frequencies permitted to be used in the relevant area can be taken out by retrieving the memory map diagram of FIG. 5 on the basis of the area information inputted by means of the personal computer 1. For example, when performing retrieval on the basis of the area information of indoor use in Japan, frequency information of four waves of 5170 MHz, 5190 MHz, 5210 MHz and 5230 MHz can be taken.

In addition to the area/frequency information of Japan (indoor use) of the 5.2 GHz broadband mobile access system (5 GHz band wireless LAN system), the above-described memory map diagram contains examples of area/frequency information of U.S.A (indoor use), U.S.A (outdoor use) and Europe (indoor use), and it is the control circuit 14 that takes charge of a relevant retrieval operation, an operation of sending the retrieved frequency information to the personal computer 1 and an operation of sending a finally selected wireless frequency into the frequency setting circuit 16.

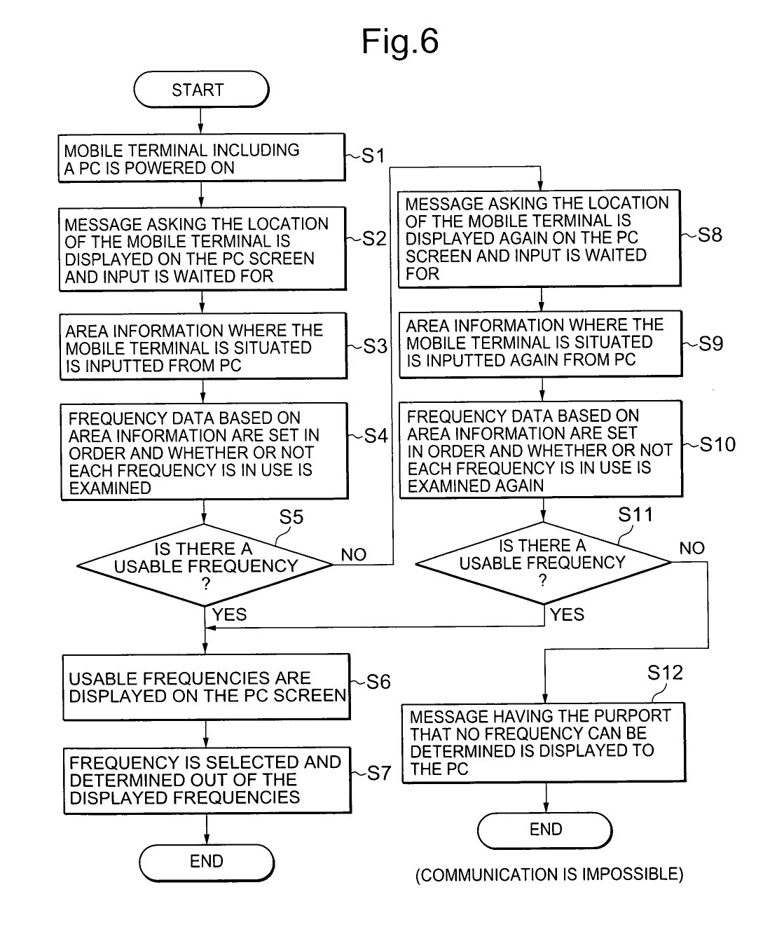

FIG. 6 is a flowchart showing an operation of setting a frequency in the wireless LAN system of FIG. 3. As shown in FIG. 6, when the personal computer 1 and the mobile terminal 2 are powered on, this mobile terminal starts an operation of setting a frequency to make it possible to communicate with an access point installed in the vicinity of it (step S1). First, application software stored in the memory 11 of the personal computer 1 is activated by control from the CPU 10 and a message screen to prompt a user to input the area information of an area where the user is currently situated appears and input is waited for (step S2). The user operates the personal computer 1 to input the area information of the area where the mobile terminal 2 is situated (step S3).

The area information inputted here is sent by the CPU 10 through the driver 12 and the PC interface circuit 13 of the mobile terminal 2 to the control circuit 14, and the control circuit 14 retrieves the memory map diagram shown in FIG. 5, said memory map diagram being stored in advance in the memory circuit, on the basis of the said area information. As a result of retrieving the memory map diagram, it takes out all of concrete frequency information of frequencies which are permitted to be used in the said area, sends the frequency information to the frequency setting circuit 16 in order, sets frequencies of the wireless transmission/reception circuit 17, and then performs reception operations.

The wireless transmission/reception circuit 17 sends a result of these reception operations to the frequency judging circuit 18, and the frequency judging circuit 18 examines whether each of these frequencies is in use or out of use to be free and sends this result of examination to the control circuit 14 (step S4).

The operation of examining whether each of the frequencies is in use or out of use to be free by means of the wireless transmission/reception circuit 17 and the frequency judging circuit 18 is performed by examining whether or not a received signal of each of the frequencies can be decoded, and a frequency bringing a carrier-busy state is judged to be in use and a frequency bringing no carrier-busy state is judged to be usable (step S5)

In case that the result of judgment of the frequency judging circuit 18 indicates that there is some usable frequency information, the control circuit 14 sends the said frequency information through the PC interface circuit 13 and the driver 12 to the CPU 10 of the personal computer 1 and displays it to the application software 11 on the personal computer screen (step S6). The user operates the personal computer 1 to click-select a frequency out of the usable frequencies displayed on the personal computer screen, and the selected frequency information is sent again to the control circuit 14 of the mobile terminal 2 and a frequency setting operation is performed in the frequency setting circuit 16 and the operation is completed (step S7).

On the other hand, in case that there is no usable frequency in an area where the mobile terminal is situated in step S5, there is the possibility that the input of area information specified by the user is wrong and a message asking the position of the mobile terminal is displayed again on the PC screen and input is waited for (step S8). The user operates the personal computer 1 to input again the area information of an area where the mobile terminal 2 is situated (step S9).

The inputted area information is sent by the CPU 10 through the driver 12 and the PC interface circuit 13 of the mobile terminal 2 to the control circuit 14, and the control circuit 14 retrieves again the memory map diagram shown in FIG. 5 stored in advance in the memory circuit on the basis of the said area information. As a result of retrieving the memory map diagram, it takes out all of concrete frequency information of frequencies permitted to be used in the said area, sends the frequency information to the frequency setting circuit 16 in order, sets frequencies of the wireless transmission/reception circuit 17, and then performs again reception operations.

The wireless transmission/reception circuit 17 sends a result of these reception operations to the frequency judging circuit 18, and the frequency judging circuit 18 examines again whether each of the frequencies is in use or out of use to be free (step S10) and sends this result of examination to the control circuit 14.

In case that the result of judgment of the frequency judging circuit 18 indicates that there is some usable frequency information, the control circuit 14 proceeds to step S6, and in case that there is no usable frequency, it sends information having the purport that no frequency can be set through the PC interface circuit 13 and the driver 12 to the CPU 10 of the personal computer 1 (step S11) and the CPU 10 indicates the purport that no frequency can be set to the application software 11 on the personal computer screen and a communication-impossible operation caused by a fact that no frequency can be set is brought and the operation is ended (step S12).

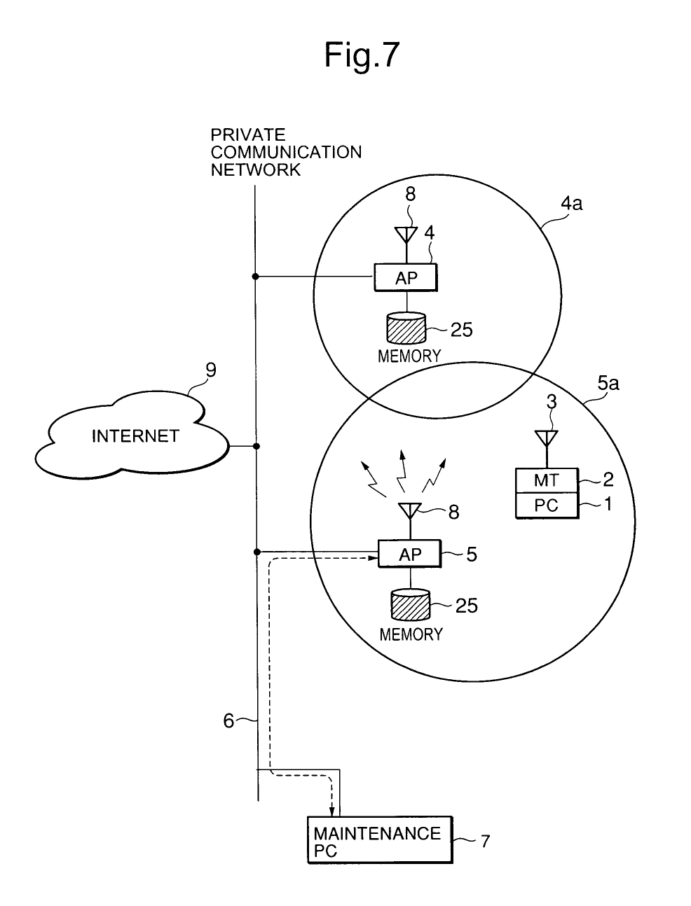

FIG. 7 is an entire schematic block diagram of a wireless LAN system showing a second embodiment of the present invention, and in this embodiment, setting of a wireless frequency is performed by an access point. This is applicable to an operation of setting a wireless frequency performed by the mobile terminal as described in FIG. 3 to FIG. 6 to the access point, and the same components as described in FIGS. 3 to 6 are provided with the same numbers.

An access point 4 and an access point 5 each of which is installed in its relevant area are connected to a private communication network (LAN) 6, which is connected to a maintenance personal computer (PC) 7 and the Internet 9 being a public communication network. Each access point is provided with a memory 25 and an antenna 8, said access point emitting a radio wave for performing a wireless communication from the antenna 8. And a service area 4a is formed by the access point 4 and a service area 5a is formed by the access point 5.

A mobile terminal 2 is moving (is present) inside the service area 5a and is performing a wireless communication with the access point 5, and a personal computer 1 is connected to the mobile terminal 2.

And the private communication network (LAN) 6 is a wire network, which comprises wire cables, optical fiber cables or the like and network devices such as a router, a hub and the like.

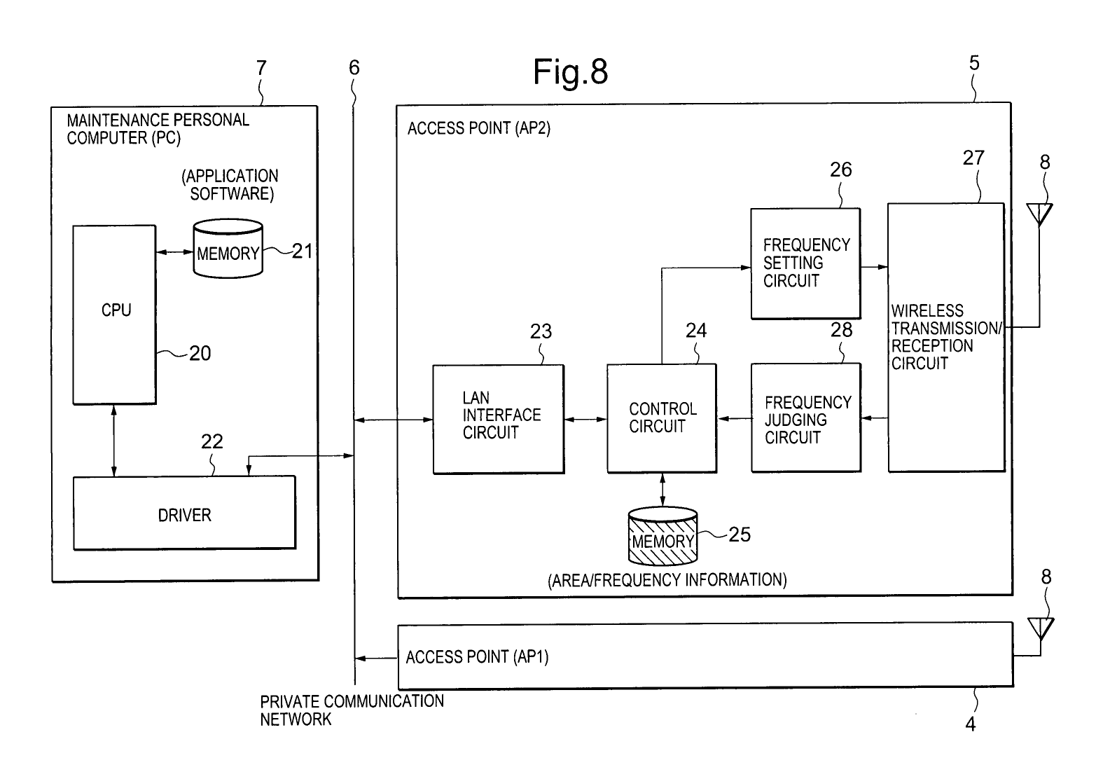

FIG. 8 is a block diagram showing the maintenance personal computer (PC) 7 and the access point 5 of FIG. 7. As shown in FIG. 8, the maintenance personal computer 7 is mounted with a CPU 20 for performing control, a memory 21 having application software stored in it and a driver 22 for taking charge of an information interface between the CPU 20 and the access point 5 through the private communication network 6, and the access point 5 comprises a LAN interface circuit 23 taking charge of an interface with the maintenance personal computer through the private communication network 6, a control circuit 24 for controlling various operations, a memory circuit 25 for storing data related to the control operations, a frequency setting circuit 26 for setting wireless frequency information sent from the maintenance personal computer 7 to a wireless transmission/reception circuit 27, a frequency judging circuit 28 for examining whether or not a frequency in each area is a free frequency being not in use, and a wireless transmission/reception circuit 27 for performing a wireless communication with a mobile terminal.

The block diagram of FIG. 8 shows only the block components taking part in a frequency setting operation, but omits block components participating in other operations (ordinary data transmission/reception operation and the like).

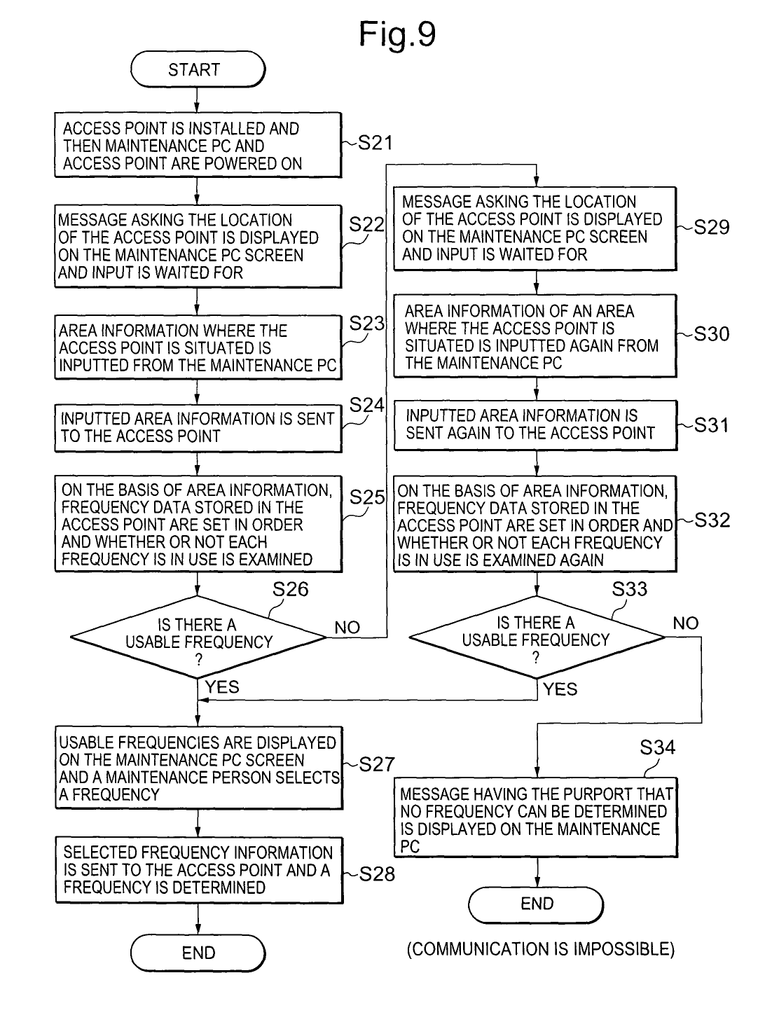

FIG. 9 is a flowchart showing an operation of setting a frequency in the wireless LAN system of FIG. 7. As shown in FIG. 9, when the access point 5 is installed and then the maintenance personal computer 7 and the access point 5 are powered on, this access point starts an operation of setting a frequency to make it possible to perform a wireless communication with a mobile terminal moving in the vicinity of it (step S21). First, application software stored in the memory 21 of the maintenance personal computer 7 is activated by control from the CPU 20 of the maintenance personal computer 7 and a message screen to prompt a maintenance person to input the area information of an area where the current access point is situated appears and input is waited for (step S22). The maintenance person operates the maintenance personal computer 7 to input the area information of an area where the access point 5 is situated (step S23).

The area information inputted here is sent by the CPU 20 through the driver 22, the private communication network 6 and the LAN interface circuit 23 of the access point 5 to the control circuit 24 of the access point 5 (step S24), and the control circuit 24 retrieves a memory map diagram stored in advance in the memory 25 on the basis of the said area information. As a result of retrieving the memory map diagram, it takes out all of concrete frequency information of frequencies which are permitted to be used in the said area, sends the frequency information to the frequency setting circuit 26 in order, sets frequencies of the wireless transmission/reception circuit 27, and then performs reception operations.

The wireless transmission/reception circuit 27 sends a result of these reception operations to the frequency judging circuit 28, and the frequency judging circuit 28 examines whether each of the frequencies is in use or out of use to be free and sends this result of examination to the control circuit 24 (step S25).

The operation of examining whether each of the frequencies is in use or out of use to be free by means of the wireless transmission/reception circuit 27 and the frequency judging circuit 28 is performed by examining whether or not a received signal of each of the frequencies can be decoded, and a frequency bringing a carrier busy state is judged to be in use and a frequency bringing no carrier busy state is judged to be usable (step S26).

In case that the result of judgment of the frequency judging circuit 28 indicates that there is some usable frequency information, the control circuit 24 sends the said frequency information through the LAN interface circuit 23, the private communication network 6 and the driver 22 to the CPU 20 of the maintenance personal computer 7 and displays it to the application software on the personal computer screen (step S27). The maintenance person operates the maintenance personal computer 7 to click-select and determine a frequency out of the usable frequencies displayed on the personal computer screen, and the determined frequency information is sent again to the control circuit 24 of the access point 5 and a frequency setting operation is performed in the frequency setting circuit 26 and the operation is completed (step S28).

On the other hand, in case that there is no usable frequency in an area where the access point is installed, there is the possibility that the input of area information specified by the maintenance person is wrong and a message asking the location (area) where the access point is installed is displayed again on the maintenance personal computer screen and input is waited for (step S29). The maintenance person operates the maintenance personal computer 7 to input again the area information of an area where the access point is situated (step S30).

The inputted area information is sent by the CPU 20 through the driver 22, the private communication network 6 and the LAN interface circuit 23 of the access point 5 to the control circuit 24 (step S31), and the control circuit 24 retrieves again the memory map diagram stored in advance in the memory circuit on the basis of the said area information. Moreover, as a result of retrieving the memory map diagram, it takes out all of concrete frequency information of frequencies which are permitted to be used in the said area, sends the frequency information to the frequency setting circuit 26 in order, sets frequencies of the wireless transmission/reception circuit 27, and then performs again reception operations.

The wireless transmission/reception circuit 27 sends a result of these reception operations to the frequency judging circuit 28, and the frequency judging circuit 28 examines again whether each of the frequencies is in use or out of use to be free (step S32) and sends this result of examination to the control circuit 24.

In case that the result of judgment of the frequency judging circuit 28 indicates that there is some usable frequency information, the control circuit 24 proceeds to step S27, and in case that there is no usable frequency, it sends information having the purport that no frequency can be set through the LAN interface circuit 23, the private communication network 6 and the driver 22 to the CPU 20 of the maintenance personal computer 7 (step S33) and the CPU 20 indicates the purport that no frequency can be set to the application software on the personal computer screen and a communication-impossible operation caused by a fact that no frequency can be set is brought and the operation is ended (step S34).

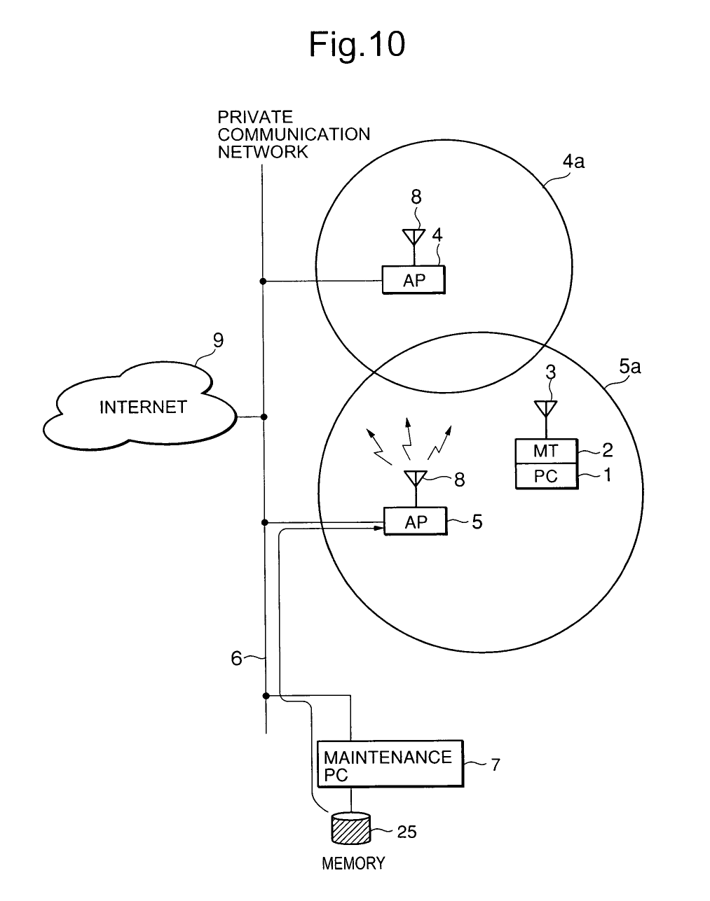

FIG. 10 is an entire schematic block diagram of a wireless LAN system showing a third embodiment of the present invention, and in this embodiment, setting of a wireless frequency is performed by a maintenance personal computer. This is applicable to an operation of setting a wireless frequency performed by the access point as described in FIG. 7 to FIG. 9 to the maintenance personal computer, and the same components as described in FIGS. 7 to 9 are provided with the same numbers.

An access point 4 and an access point 5 each of which is installed in its relevant area are connected to a private communication network (LAN) 6, which is connected to a maintenance personal computer (PC) 7 and the Internet 9 being a public communication network, and the maintenance personal computer 7 has a memory 25 connected to it. Each access point is provided with an antenna 8 and emits a radio wave for performing a wireless communication from its antenna 8. And a service area 4a is formed by the access point 4 and a service area 5a is formed by the access point 5.

A mobile terminal 2 is moving (is present) inside the service area 5a and is performing a wireless communication with the access point 5 through an antenna 3, and a personal computer 1 is connected to the mobile terminal 2.

In addition, the private communication network (LAN) 6 is a wire network, which comprises wire cables, optical fiber cables or the like and network devices such as a router, a hub and the like.

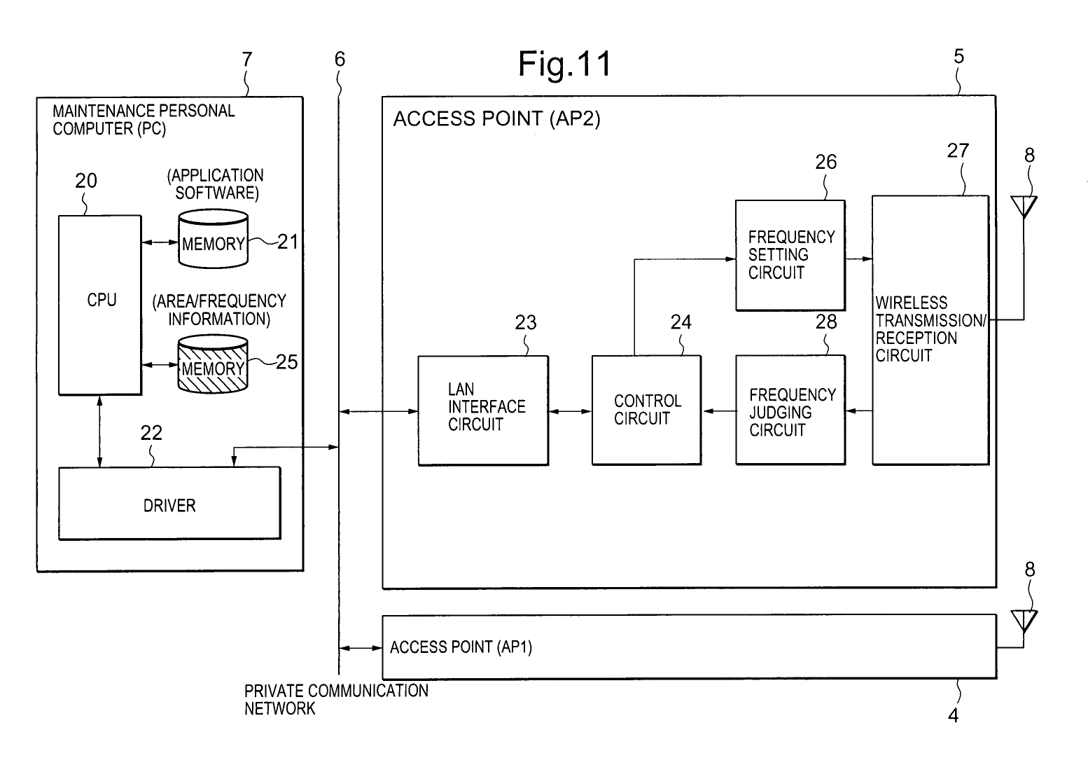

FIG. 11 is a block diagram showing the maintenance personal computer (PC) 7 and the access point 5 of the wireless LAN system of FIG. 10. As shown in FIG. 11, the maintenance personal computer 7 is mounted with a CPU 20 for performing control, a memory 21 having application software stored in it, a memory 25 having area/frequency information stored in it and a driver 22 taking charge of an information interface between the CPU 20 and the access point 5 through the private communication network 6, and the access point 5 comprises a LAN interface circuit 23 taking charge of an interface with the maintenance personal computer through the private communication network 6, a control circuit 24 for controlling various operations, a frequency setting circuit 26 for setting wireless frequency information sent from the maintenance personal computer 7 to a wireless transmission/reception circuit 27, a frequency judging circuit 28 for examining whether or not a frequency in each area is a free frequency being not in use, and a wireless transmission/reception circuit 27 for performing a wireless communication with a mobile terminal.

The block diagram of FIG. 11 shows only the block components taking part in a frequency setting operation, but omits block components participating in other operations (ordinary data transmission/reception operation and the like).

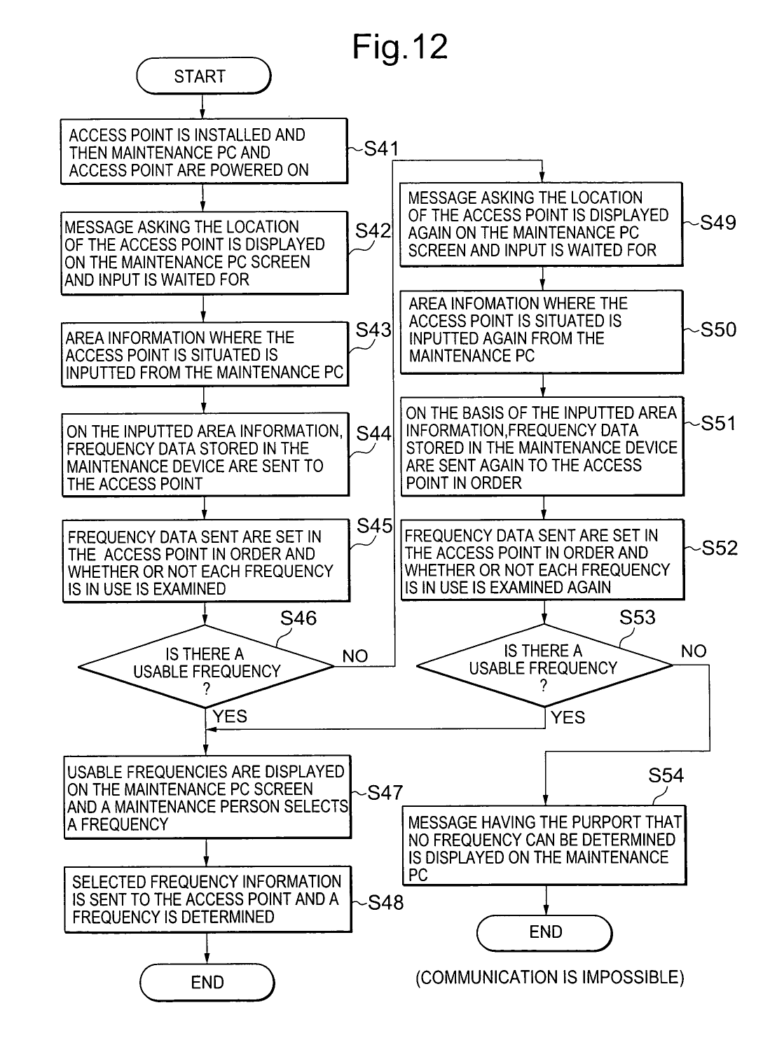

FIG. 12 is a flowchart showing an operation of setting a frequency in the wireless LAN system of FIG. 10. As shown in FIG. 12, when the access point 5 is installed and then the maintenance personal computer 7 and the access point 5 are powered on, the said access point starts an operation of setting a frequency to make it possible to perform a wireless communication with a mobile terminal moving in the vicinity of it (step S41). First, application software stored in the memory 21 of the maintenance personal computer 7 is activated by control from the CPU 20 of the maintenance personal computer 7 and a message screen to prompt a maintenance person to input the area information of an area where the current access point is situated appears and input is waited for (step S42). The maintenance person operates the maintenance personal computer 7 to input the area information of an area where the access point 5 is situated (step S43).

Hereupon, the CPU 20 retrieves a memory map diagram stored in advance in the memory 25 on the basis of the inputted area information. Moreover, as a result of retrieving the memory map diagram, it takes out all of concrete frequency information of frequencies which are permitted to be used in the said area, sends the frequency information to the control circuit 24 of the access point 5 through the driver 22, the private communication network 6 and the LAN interface circuit 23 of the access point 5 (step S44) and the control circuit 24 sends all of the received concrete frequency information to the frequency setting circuit 26 in order, sets frequencies of the wireless transmission/reception circuit 27, and then performs reception operations.

The wireless transmission/reception circuit 27 sends a result of these reception operations to the frequency judging circuit 28, and the frequency judging circuit 28 examines whether each of the frequencies is in use or out of use to be free and sends this result of examination to the control circuit 24 (step S45).

The operation of examining whether each of the frequencies is in use or out of use to be free by means of the wireless transmission/reception circuit 27 and the frequency judging circuit 28 is performed by examining whether or not a received signal of each of the frequencies can be decoded, and a frequency bringing a carrier busy state is judged to be in use and a frequency bringing no carrier busy state is judged to be usable (step S46).

In case that the result of judgment of the frequency judging circuit 28 indicates that there is some usable frequency information, the control circuit 24 sends the said frequency information through the LAN interface circuit 23, the private communication network 6 and the driver 22 to the CPU 20 of the maintenance personal computer 7 and displays it to the application software on the personal computer screen. The maintenance person operates the maintenance personal computer 7 to click-select and determine a frequency out of the usable frequencies displayed on the personal computer screen (step S47), and the determined frequency information is sent again to the control circuit 24 of the access point 5 and a frequency setting operation is performed in the frequency setting circuit 26 and the operation is completed (step S48).

On the other hand, in case that there is no usable frequency in an area where the access point is installed, there is the possibility that the input of area information specified by the maintenance person is wrong and a message asking the location (area) where the access point is installed is displayed again on the maintenance personal computer screen and input is waited for (step S49). The maintenance person operates the maintenance personal computer 7 to input again the area information of an area where the access point 5 is situated (step S50).

Hereupon, the CPU 20 retrieves a memory map diagram stored in advance in the memory 25 on the basis of the inputted area information. And as a result of retrieving the memory map diagram, it takes out all of concrete frequency information of frequencies which are permitted to be used in the said area, sends again the frequency information to the control circuit 24 of the access point 5 through the driver 22, the private communication network 6 and the LAN interface circuit 23 of the access point 5 (step S51), and the control circuit 24 sends all of the received concrete frequency information to the frequency setting circuit 26 in order, sets frequencies of the wireless transmission/reception circuit 27, and then performs reception operations.

The wireless transmission/reception circuit 27 sends a result of these reception operations to the frequency judging circuit 28, and the frequency judging circuit 28 examines whether each of the frequencies is in use or out of use to be free (step S52) and sends this result of examination to the control circuit 24.

In case that the result of judgment of the frequency judging circuit 28 indicates that there is some usable frequency information, the control circuit 24 proceeds to step S47, and in case that there is no usable frequency, it sends information having the purport that no frequency can be set through the LAN interface circuit 23, the private communication network 6 and the driver 22 to the CPU 20 of the maintenance personal computer 7 (step S53) and the CPU 20 indicates the purport that no frequency can be set to the application software on the personal computer screen and a communication-impossible operation caused by a fact that no frequency can be set is brought and the operation is ended (step S54).

Finally, although the above-mentioned embodiments of the invention have been described by way of examples composed of two access points and one mobile terminal, in the present invention the number of access points and the number of mobile terminals are not limited to these examples but can take an arbitrary value on the basis of a system design.

As described above, the present invention brings the effect of being capable of providing a wireless LAN system being better in operability and a method for setting a frequency in the same system which make it possible to determine a frequency through a small amount of operation by providing a user or a maintenance person with frequency information obtained by automatically judging whether or not a frequency conforms to the frequency specifications in each area or whether or not a frequency is a free frequency being not in use in each area.

While this invention has been described in connection with certain preferred embodiments, it is to be understood that the subject matter encompassed by way of this invention is not to be limited to those specific embodiments. On the contrary, it is intended for the subject matter of the invention to include all alterative, modification and equivalents as can be included within the spirit and scope of the following claims.

What is claimed is:

1. A wireless LAN system having an access point connected through a wire network and a mobile terminal performing a wireless communication with said access point, said wireless LAN system comprising;
a selection circuit for selecting a wireless frequency usable in a relevant area out of stored wireless frequency data on the basis of the area information inputted into said mobile terminal at the time of setting a frequency for performing a wireless communication, and
a communication circuit through which said access point and said mobile terminal perform a wireless communication with each other by means of the wireless frequency selected by said selection circuit.

2. A wireless LAN system according to claim 1, wherein said stored wireless frequency data include area information and all permitted wireless frequency values corresponding to the said area information.

3. A wireless LAN system according to claim 2, wherein said selection circuit performs reception operations by means of all wireless frequency values permitted in said area, displays wireless frequencies bringing no carrier-busy state as a result of said reception operations as usable frequencies to said mobile terminal, and makes a communication frequency be selected out of said usable frequencies by operation of said mobile terminal.

4. A wireless LAN system having an access point connected through a wire network, a mobile terminal performing a wireless communication with said access point and a maintenance device, said wireless LAN system comprising;
a selection circuit for selecting a wireless frequency usable in a relevant area out of wireless frequency data stored in said access point on the basis of the area information inputted into said maintenance device at the time of setting a frequency for performing a wireless communication, and
a communication circuit through which said access point and said mobile terminal perform a wireless communication with each other by means of the wireless frequency selected by said selection circuit.

5. A wireless LAN system according to claim 4, wherein said stored wireless frequency data include area information and all permitted wireless frequency values corresponding to the said area information.

6. A wireless LAN system according to claim 5, wherein said selection circuit performs reception operations by means of all wireless frequency values permitted in said area, displays wireless frequencies bringing no carrier-busy state as a result of said reception operations as usable frequencies to said maintenance device, and makes a communication frequency be selected out of said usable frequencies by operation of said maintenance device.

7. A wireless LAN system having an access point connected through a wire network, a mobile terminal performing a wireless communication with said access point and a maintenance device, said wireless LAN system comprising;
a selection circuit for selecting a wireless frequency usable in a relevant area out of wireless frequency data stored in said maintenance device on the basis of the area information inputted into said maintenance device at the time of setting a frequency for performing a wireless communication, and
a communication circuit through which said access point and said mobile terminal perform a wireless communication with each other by means of the wireless frequency selected by said selection circuit.

8. A wireless LAN system according to claim 7, wherein said stored wireless frequency data include area information and all permitted wireless frequency values corresponding to the said area information.

9. A wireless LAN system according to claim 8, wherein said selection circuit performs reception operations by means of all wireless frequency values permitted in said area, displays wireless frequencies bringing no carrier-busy state as a result of said reception operations as usable frequencies to said maintenance device, and makes a communication frequency be selected out of said usable frequencies by operation of said maintenance device.

10. A mobile terminal of a wireless LAN system, said mobile terminal comprising;
a selection circuit for selecting a wireless frequency usable in a relevant area out of wireless frequency data stored in said terminal on the basis of the area information inputted into said mobile terminal at the time of setting a wireless frequency for performing a wireless communication with an access point, and
a communication circuit for performing a wireless communication with said access point by means of the wireless frequency selected by said selection circuit.

11. A mobile terminal according to claim 10, wherein said stored wireless frequency data include area information and all permitted wireless frequency values corresponding to the said area information.

12. A mobile terminal according to claim 11, wherein said selection circuit performs reception operations by means of all wireless frequency values permitted in said area, displays wireless frequencies bringing no carrier-busy state as a result of said reception operations as usable frequencies, and makes a communication frequency be selected out of said usable frequencies.

13. An access point of a wireless LAN system, being connected to a maintenance device through a wire network, said access point comprising;
a selection circuit for selecting a wireless frequency usable in a relevant area out of wireless frequency data stored in its own device or said maintenance device on the basis of the area information inputted into said maintenance device at the time of setting a wireless frequency for communicating with a mobile terminal, and
a communication circuit for performing a wireless communication with said mobile terminal by means of the wireless frequency selected by said selection circuit.

14. An access point according to claim 13, wherein said stored wireless frequency data include area information and all permitted wireless frequency values corresponding to the said area information.

15. An access point according to claim 14, wherein said selection circuit performs reception operations by means of all wireless frequency values permitted in said area, sends wireless frequencies bringing no carrier-busy state as a result of said reception operations as usable frequencies to said maintenance device, and makes a communication frequency be selected out of said usable frequencies by operation of said maintenance device.

16. An access point of a wireless LAN system, being connected to a maintenance device having a man-machine interface through a wire network and performing a wireless communication with a mobile terminal, said access point comprising;
a transmission circuit for performing reception operations by means of all wireless frequency values permitted in a relevant area, said wireless frequency values being stored in said maintenance device or its own device, on the basis of the area information inputted through said man-machine interface of said maintenance device at the time of setting a wireless frequency for communicating with a mobile terminal, and
a selection circuit for making a communication frequency be selected out of said usable frequencies by operation of said maintenance device.

17. A method for setting a frequency in a wireless LAN system having an access point and a maintenance device connected to each other through a wire network and a mobile terminal performing a wireless communication with said access point, said method comprising;
a step of selecting a wireless frequency usable in a relevant area out of stored wireless frequency data on the basis of the area information inputted at the time of setting a wireless frequency for the wireless LAN system to communicate, and
a step of making said mobile terminal and said access point perform a wireless communication with each other by means of said selected wireless frequency.

18. A method for setting a frequency in a wireless LAN system according to claim 17, wherein said stored wireless frequency data include area information and all permitted wireless frequency values corresponding to the said area information.

19. A method for setting a frequency in a wireless LAN system according to claim 18, wherein said selection of a usable wireless frequency is performed by performing reception operations by means of all wireless frequency values permitted in said area, sending wireless frequencies bringing no carrier-busy state as a result of said reception operations as usable frequencies to said maintenance device or said mobile terminal, and making a communication frequency be selected out of said usable frequencies by said maintenance device or said mobile terminal.

20. A method for setting a frequency in a wireless LAN system comprising a maintenance device having a man-machine interface, an access point connected to a wire network and a mobile terminal performing a wireless communication with said access point, wherein;
said access point performs reception operations by means of all wireless frequency values permitted in a relevant area stored in the maintenance device or the access point on the basis of the area information inputted through the man-machine interface of the maintenance device at the time of setting a wireless frequency for said access point to communicate with the mobile terminal, sends wireless frequencies bringing no carrier-busy state as a result of said reception operations as usable frequencies to a maintenance person and makes the maintenance person select a communication frequency out of said usable frequencies, and
said mobile terminal performs reception operations by means of all wireless frequency values permitted in a relevant area, said wireless frequency values being stored in the mobile terminal, on the basis of the area information inputted through the man-machine interface of the mobile terminal at the time of setting a wireless frequency for said mobile terminal to communicate with the access point, sends wireless frequencies bringing no carrier-busy state as a result of said reception operations as usable frequencies to a user and makes the user select a communication frequency out of said usable frequencies.
